(19) United States
(12) Patent Application Publication
(10) Pub. No.: US 2015/0241851 A1
(43) Pub. Date: Aug. 27, 2015

(54) Men,Women,Nectie Med Timer Watchs. And The Home Med Timer Clock.

(71) Applicant: Vola Gran Smith, Lancaster, TX (US)

(72) Inventor: Vola Gran Smith, Lancaster, TX (US)

(21) Appl. No.: 14/187,402

(22) Filed: Feb. 24, 2014

(51) Int. Cl. G04G 13/02; A61J 7/04

(52) U.S. Cl. CPC G04G 13/02; A61J 7/0409

(57) ABSTRACT

The purpose of this Technical disclosure of my invention is That there is no function device in the market field that will Help people to remember to take there medication on time, Whether the person is at home are out of the house for the Day, are Traveling for a day; This technology will allow People to continue with there daily routine, But at the voice Sound of the med timer watches or Home med timer clock Will refresh any one remember, not just one voice Sound activate but five minutes later another voice Sound is activate. The Watches that are on page 1, 2 or Blow
1. Button 1 is to first push the recording control button to input voice in to watch. There is input recording of the voice at the button of the watch.
2. Button 2 is the Time and Date control.
3. Part 3 is a battery Red light that will blink to let the person know they have one hour to replace the battery.
4. Part 4 is the pill holder that coexist with the voice activate wish the pill holder will open on the risk band of the watch.

### DETAILED DESCRIPTION

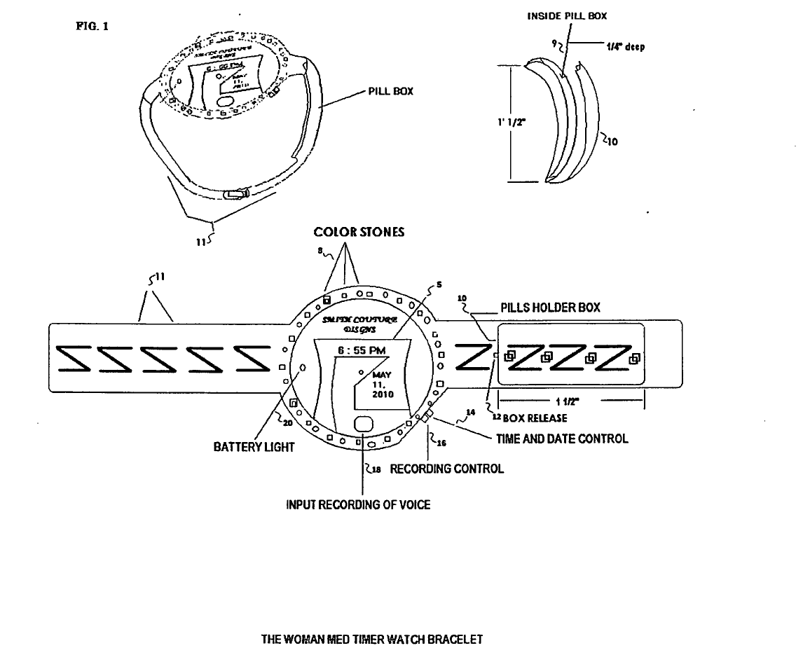

FIG. 1 This view of the Med timer Women watch med Voice timer bracelet will show the outer part; (8) The shape of Stone are difference on the Women watch. (9) The inside Opening and closure of the watch holds pills in box container. (12) The women watch has a lock release to secure medication The Women watch come in difference variety of material and color with stones in bed in side the watch bracelets. (10) Each watch has a unique design cover on top of pills holder box. (11) bottom part of the med timer watch is flexible. (5) The lady med timer watch show the couture of the digital Side of the Time and Date, with a back lighting. (14) The Time and date control button, to set the watch. (16) This is The button to record the voice on to the med timer watch. (18) This is where the person will speak to input the voice Sound. (20) Show the red battery light that will blink for one Hour be for battery is expired time.

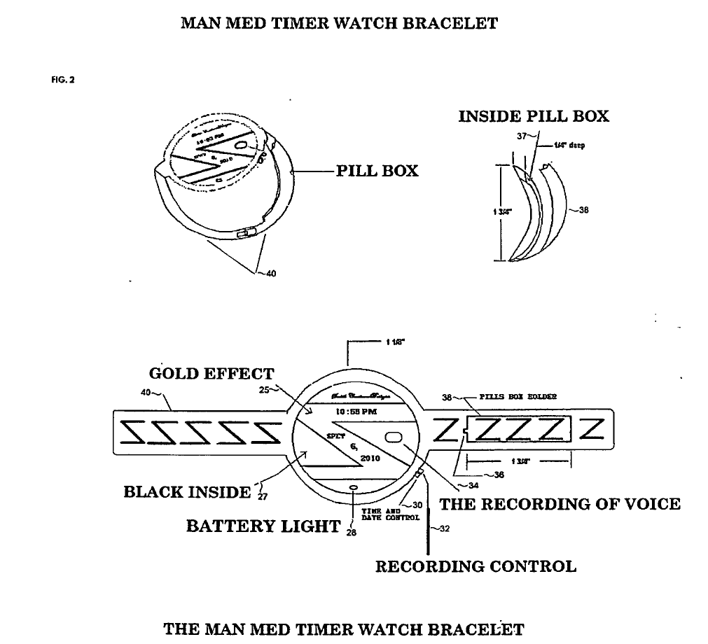

FIG. 2 The view of this Med timer men watch is uniquely design with difference color and with style to show. (37) The inside are wide enough on the men watch, The med timer Opening and closure of the watch holds a deep box container. (36) This men watch has a lock release to secure medication, This med timer men watch is rain water proof (25) this men Watch are with gold effect back ground with time and date, that is ready to be use. (27) A black inside with a slashing Light. (40) The bottom part of the men timer watch is flexible. The men timer watch is with couture in of digital setting. (28) come with a battery light that blinks to let a person know they Have one hour to exchange the battery out. (32) This is the button to record the voice on to the med timer watch. (34) This is where the person will speak to input the voice. (30) the men med timer watch show the couture of the digital facing of The Time and Date; to set watch hold button down. (38) The cover is very uniquely design just to keep rain water out.

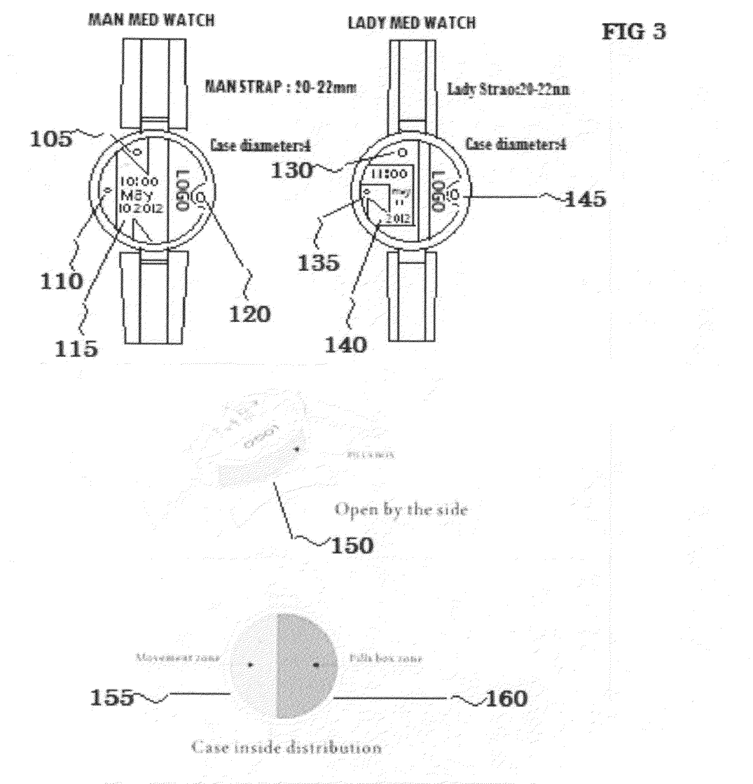

FIG. 3 (150) Show the lady and men watch show the pills Opening on the pill container on the side of the watch it self. (145), (120) Cover that snap on the top of the watch to hold Down and lock in the pills that are in the container. There for rain water proof. (105), (130) Voice sound is input in to watch. (110), (135) Is where the battery blinking light for timer watch. (115), (140) Both med timer watch are digital with unique style and come with flexible band; both come with voice activated Sound to tell a person it time to take their medication. (155) Show how both med timer watch is constructed; one side by Side; and on one side the inside distribution for electronics PC component, And (160) this is the case inside Pill distribution These are very fashionable med Timer Watch bracelets along with the other and has no none Compatible to other watches and bracelets, as on high with new Levels of marketing.

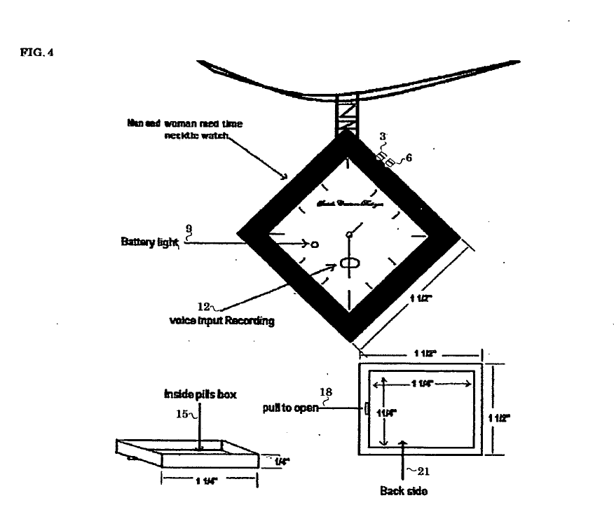

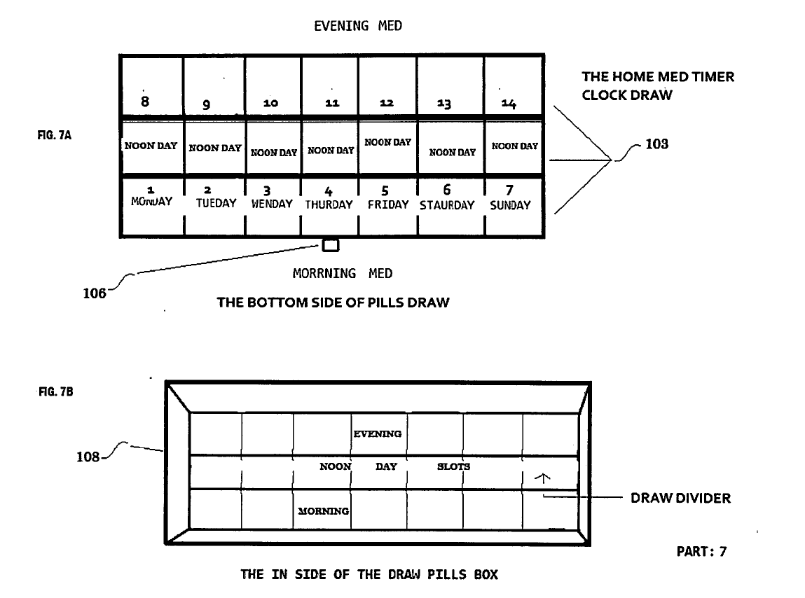

FIG. 4 Show how the Necktie med watch is constructed; (3) is to hold down button to set the time and date. (6) This Button is to hold down to input voice sound into watch Voice sound will let you it time to take medication. (9) This Is the red battery light that blink for one hour be for going out Battery has to be change. (12) Input recording voice into Med timer Necktie watch to activate sound to work watch. (21) on the back side of watch the pill draw will slide out and The draw is water proof. (18) To open the draw push to open Then pull draw out. (15) in side this pill box will secure and Protect the medication. FIG. 4 this Necktie med timer watch Will be a great product for the market place. FIG. 1- FIG. 7 And all paper work here in is Claim by me and There for I am The Original owner of this function Invention. Each Product Is uniquely design with style and is voice activate sound.

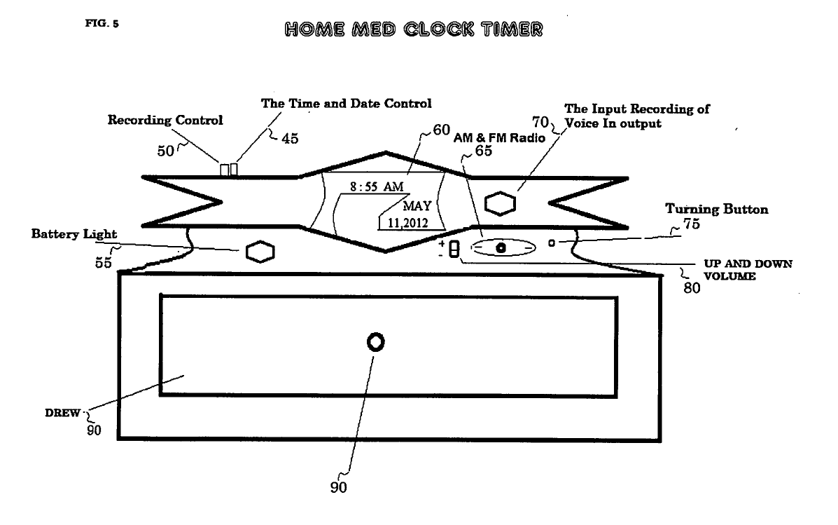

FIG. 5 Is the home med clock timer; (70) The Clock Voice activate sound that will talk to you and let you know it's Time to take the medication; the recording input and output of Of the voice are activate. (60) A digital time and date. (45) Time and date Control push down button. (50) The recording Control button that will help to record voice in to clock input. (90) Draw will spring out and open at voice activation sound The room where the home med clock timer is located they will See the draw is open; draw will not close until a person push The draw back in to the clock. (55) The blinking battery light (65) This med time clock is Am and Fm Radio. (75) A button To turn Two different stations. (80) to push up for volume or Down to lower volume. (90) If pills still in side the draw you'll Know that they have not taking there medication if the draw Is still open.

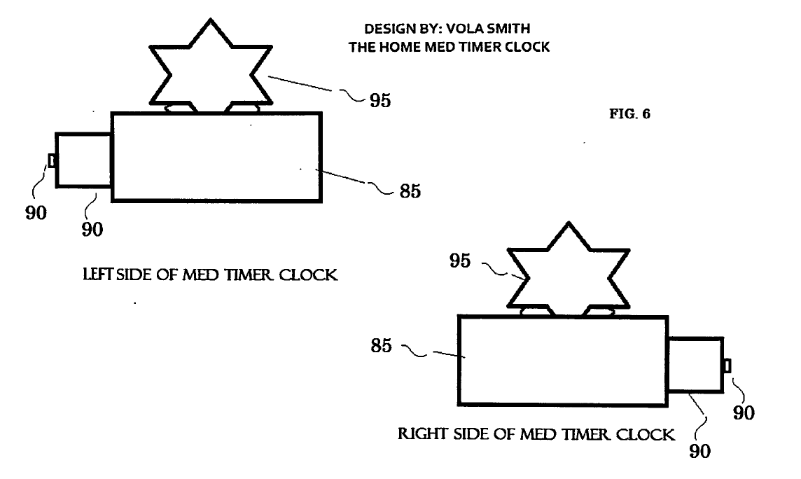

FIG. 6 Is the side of the Clock; (85) show on the left side in The right of the med timer clock. (90) Show the draw have Come out of the clock box with the knob to close the draw back (95) Is where the unique electronics component brain activate And located, To make this med timer clock function. FIG. 7A (103) At the bottom show individual slots for Monday Through Sunday, and three time a day. (106) The knob to push 87 Draw back into clock box. FIG. 7B (108) is how the in side will Look. This draw will come out of the clock at activate sound of The input of the Voice to let the person know it is time to take There Medication; that is on time no more for getting. And And this entity here in described I am the original inventor And One owner claim of each products here in described.

### THE NECKTIE WATCH

The Purpose of this Necktie Med Timer Watch technology invention is that it has a voice input, also red blinking battery light to alert you that you have 1 hour to change out the battery.
1. Button 1 The push Time and Date control
2. Button 2 to press down and hold to record voice in to watch.

### The Necktie Watch

Part 3 at the sound of the voice activation pills drew can be slide out from the side of watch, This Med timer Necktie watch can be worn by man or woman.

### Men and Woman Med Timer Watch

The purpose of this Technical disclosures of my invention is to supply the market place with a function device that the world can use to help keep there mind active to remember; On page 4 this med timer men and women watch open by the side in pills or inserted into for safe keeping until it is time to take the medication.

1. Button 1 is voice input and out put.

2. Button 2 Time and Date control

3. One hour Red battery light blinks be for going out.

4. All watch are water proof.

### The Home Med Clock Timer

1. This Home Med Clock Timer function device disclosure invention is the kind of technology that every person that take medication make want to have at home or in there office. On this home med clock timer at the sound of the voice alert the draw will automatically open. It has three drew morning, noon, and evening for medication to go into.

### The Home Med Clock Timer

2. Button 1 push to enter recording of the voice

3. Button 2 Push to control time and date. (Digital)

4. This Technology come with FM and AM Radio with Volume and Tuning.

5. Red battery light alert one hour be for battery is out.

6. This device had a home electric input plug.

1. I distinctly claim these matter which this invention technology function as it speaks the time, the sound and alert the person it is time to take their medication. On art drawing page 1, 2, 3, 4, 5, 6, 7 are my claim to this invention I' am the inventor. And all the input information here.
